(19) United States
(12) Patent Application Publication
(10) Pub. No.: US 2014/0077405 A1
(43) Pub. Date: Mar. 20, 2014

(54) Manufacturing Device and Manufacturing Method of Polyolefin Microporous Film

(71) Applicant: Hidehiko Funaoka, Tokyo (JP)

(72) Inventor: Hidehiko Funaoka, Tokyo (JP)

(73) Assignee: Tetsuro Nogata, Kanagawa (JP)

(21) Appl. No.: 14/114,920

(22) PCT Filed: May 2, 2011
(86) PCT No.: PCT/JP2011/002540

§ 371 Date: Oct. 31, 2013

(51) Int. Cl. B29D 7/01

(52) U.S. Cl. CPC B29D 7/01
USPC 264/41; 425/4 R

(57) ABSTRACT

Devices and methods of manufacturing a polyolefin microporous film are disclosed. An exemplary device includes a movement mechanism having a constraining means capable of mechanically constraining both widthwise edge parts of the strip-like and film-like microporous film precursor in the drying chamber; a drying means and a liquid seal tank. An exemplary method includes a step for mechanically constraining both widthwise edge parts of the strip-like and film-like microporous film precursor and a step for conveying the foregoing film precursor into the drying chamber. Another exemplary method includes a step for mechanically constraining both widthwise edge parts of the strip-like and film-like microporous film precursor at an entrance side of the drying chamber, a step for commencing extracting of the plasticizer from the film-like microporous film precursor, and a step for conveying the strip-like and film-like microporous film precursor into the drying chamber and for heating the foregoing film precursor.

### FIELD OF THE INVENTION

The present invention relates to a device and method for manufacturing a polyolefin microporous film, and in particular, to a device and method for manufacturing a polyolefin microporous film in which it is possible to suppress shrinkage during a drying process, to enhance uniformity of quality, and to achieve a high-speed continuous production.

### BACKGROUND OF THE INVENTION

Conventionally, microporous films have been used as a separator, which is a material used in devices such as battery cells and electrolytic capacitors. Demand for power storage devices in which the said separator is used is rapidly growing in recent years as power storages devices (in particular, for lithium ion secondary cells) for hybrid automobiles, electric automobiles and a power generation system in which renewable energy is used, such as solar power generation, in addition to the demand for conventional power storage devices for small electronic and electric instruments. With an increase in energy density, output power, and size of battery cells, there is increasing demand for uniformity of quality, in addition to a high quality, with regards to separators.

Electrolytic fluids and agents such as materials for activating positive and negative electrodes are used in lithium secondary cells, and as a result, a polyolefin-based polymer, particularly polyethylene or polypropylene, is generally used as the material for the separator (microporous film), taking into consideration the affinity with and the chemical resistance to the electrolytic fluid.

With regards to manufacturing, a microporous film made from a polyolefin, the technique for obtaining a microporous film in which a microporous film precursor is formed by phase separation from a composition comprising a polymer and a plasticizer is well-known, and applying a stretching process, extracting the plasticizer using a solvent after stretching into the form of a sheet, and drying and removing the solvent (Patent Document 1).

In the step for drying and removing the solvent and obtaining a microporous film, conventionally, a strip-like microporous film containing the solvent is extended round a cylindrical roll, and the solvent is subjected to a drying process while the roll is turned so as to convey the microporous film. Specifically, hot air is blown using an air blow nozzle onto the microporous film on, e.g., a heating roll, whereby the solvent is caused to evaporate.

Prior art documents related to the field of the invention include Patent Document 1 such as Japanese Laid-open Patent Application No. 11-60789.

### SUMMARY OF THE INVENTION

Devices and methods for manufacturing polyolefin microporous films are disclosed. In one example, a device for manufacturing a polyolefin resin film allows for obtaining a microporous film and stretching the plasticizer into a form of film for making into a strip-like and film-like microporous film precursor. In one example, the device includes (a) a movement mechanism having a constraining means capable of mechanically constraining both widthwise edge parts of the strip-like and film-like microporuous film precursor in the drying chamber, where the movement mechanism conveys the strip-like and film-like microporous film precursor in a state in which both widthwise edge parts of the strip-like and film-like microporous film precursor are constrained by the constraining means; (b) a drying means for heating, in air, the strip-like and film-like microporous film precursor conveyed by the movement mechanism and for causing the solvent or the plasticizer to evaporate from the strip-like and film-like microporous film precursor; and (c) a liquid seal tank for storing a predetermined sealing liquid, the sealing liquid segregating the atmosphere in the drying chamber from the external atmosphere, wherein both widthwise edge parts of the strip-like and film-like microporous film precursor are constrained by the constraining means in the sealing liquid in the liquid seal tank.

In one example, the method for manufacturing a polyolefin microporous film in which a microporous film precursor is obtained by mixing a polyolefin resin material and stretching the plasticizer into a form of a film and making it into a strip-like and film-like microporous film precursor and a process for replacing the plasticizer with a solvent, followed by evaporating and drying the solvent in a drying chamber or a process for evaporating and drying the plasticizer in a drying chamber is performed, includes (a) a step for mechanically constraining both widthwise edge parts of the strip-like and film-like microporous film precursor before the drying process; and (b) a step for conveying the strip-like and film-like microporous film precursor into the drying chamber in a state in which both widthwise edge parts of the strip-like and film-like microporous film precursor are mechanically constrained and for heating the strip-like and film-like microporous film precursor being conveyed, thereby causing the solvent or the plasticizer to evaporate from the strip-like and film-like microporous film precursor.

In yet another example of a method, a method for manufacturing a polyolefin microporous film in which a microporous film precursor obtained by mixing a polyolefin resin material and a plasticizer is stretched into the form of a film and made into a strip-like and film-like microporous film precursor, and the continuously conveyed film-like microporous film precursor is subjected to a process of replacing the plasticizer with a solvent, followed by evaporating and drying the solvent in the drying chamber; the method includes (a) a step for commencing extraction of the plasticizer from the film-like microporous film precursor using a solvent in an extraction solvent tank disposed upstream of the drying chamber; and (b) a step for conveying the strip-like and film-like microporous film precursor into the drying chamber and for heating the strip-like and film-like microporous film precursor being conveyed, thereby causing the solvent to evaporate from the strip-like and film-like microporous film precursor, wherein the extraction of the plasticizer is commenced in the extraction solvent tank after both widthwise edge parts of the strip-like and film-like microporous film precursor are mechanically constrained at the entrance side of the drying chamber.

### BRIEF DESCRIPTION OF DRAWINGS

Further features and advantages of the invention will become apparent from reading the following detailed description in conjunction with the following drawings, in which like reference numbers refer to like parts:

FIG. 1 is a block diagram showing the schematic configuration of a device for manufacturing a polyolefin microporous film (microporous film manufacturing device) according to one example of the present invention;

FIG. 2 is a cross-sectional view schematically showing the partial configuration of FIG. 1;

FIG. 3 is a cross-sectional view of a tenter provided to the microporous film manufacturing device shown in FIG. 1; and

FIG. 4 shows the flow of steps performed by the microporous film manufacturing device in FIG. 1.

### DETAILED DESCRIPTION

The examples and drawings provided in the detailed description are merely examples, and should not be used to limit the scope of the claims in any claim construction or interpretation.

### Problems to be Solved by the Invention

However, a problem is presented in that when a microporous film is dried while being conveyed at high speed and a high temperature on a heating roll, shrinkage occurs along the width direction of the film, causing a decrease in permeability. In addition, the shrinkage is greater towards the edges than at the center of the film, preventing a microporous film having a uniform quality from being obtained.

In addition, when a microporous film is subjected to a drying process while being conveyed at high speed using a roll as described above, the shrinkage during the drying causes the film to crease, making the drying process incomplete. Therefore, the speed at which the microporous film is conveyed must be kept low, preventing the production speed from being increased.

The present invention was conceived in light of the abovementioned point. One object of the present invention is to provide a device and method for manufacturing a polyolefin microporous film in which it is possible to minimize shrinkage of the polyolefin microporous film during the drying process, enhance uniformity of quality, and achieve high-speed continuous productivity.

### Means Used to Solve the Above-Mentioned Problems

In order to achieve the aforementioned object, a device for manufacturing a polyolefin microporous film according to one example of the present invention is a device for manufacturing a polyolefin microporous film in which a microporous film precursor obtained by mixing a polyolefin resin material and a plasticizer is stretched into the form of a film and made into a strip-like and film-like microporous film precursor and a process for replacing the plasticizer with a solvent, followed by evaporating and drying the solvent in a drying chamber or a process for evaporating and drying the plasticizer in a drying chamber is performed; the device comprising: a movement mechanism having a constraining means capable of mechanically constraining both widthwise edge parts of the strip-like and film-like microporous film precursor in the drying chamber, the movement mechanism conveying the strip-like and film-like microporous film precursor in a state in which both widthwise edge parts of the strip-like and film-like microporous film precursor are constrained by the constraining means; a drying means for heating, in air, the strip-like and film-like microporous film precursor conveyed by the movement mechanism, and causing the solvent or the plasticizer to evaporate from the strip-like and film-like microporous film precursor; and a liquid seal tank for storing a predetermined sealing liquid, the sealing liquid segregating the atmosphere in the drying chamber from the external atmosphere, wherein both widthwise edge parts of the strip-like and film-like microporous film precursor are constrained by the constraining means in the sealing liquid in the liquid seal tank.

The movement mechanism preferably conveys the film-like microporous film precursor upwards in a state in which both widthwise edge parts of the film-like microporous film precursor are constrained by the constraining means.

In addition, the constraining means and the movement mechanism are preferably a clip-type tenter, and the tenter is preferably provided with a pair of rails provided on widthwise edges of the strip-like and film-like microporous film precursor, and bearings that roll on the rails or a slide member that slides on the rails, and wherein a composite material comprising a solid lubricant and a metal being used for the bearing or for at least one of the rail and the slide member.

A configuration of such description results in both widthwise edge parts of the film-like microporous film precursor being mechanically constrained in the seal liquid by the movement mechanism, therefore making it possible to completely prevent the film-like microporous film precursor from creasing.

In addition, mechanically constraining both widthwise edges of the strip-like and film-like microporous film precursor eliminates the risk of a widthwise shrinkage even if the film-like microporous film precursor is heated and dried makes it possible to perform conveying at a high speed and drying at a high temperature, thereby achieving high-speed continuous productivity. Since no widthwise shrinkage takes place during drying, the permeability does not decrease, and the uniformity in quality can also be enhanced.

In addition, conveying the film-like microporous film precursor upwards makes it easier to mechanically constrain both widthwise edge parts of the film-like microporous film precursor before the film shrinks, and makes it possible to downwardly wash off and efficiently remove the seal liquid adhering to the obverse and reverse surfaces of the film-like microporous film precursor.

The device for manufacturing a polyolefin microporous film preferably comprises: a preliminary drying chamber provided at a stage before the drying chamber, the preliminary drying chamber being separated from the drying chamber by the liquid seal tank; conveying means for conveying the film-like microporous film precursor in the preliminary drying chamber and for conveying the film-like microporous film precursor from the preliminary drying chamber through the liquid seal tank into the drying chamber; and means capable of drying the film-like microporous film precursor conveyed by the conveying means in the preliminary drying chamber.

Thus providing a preliminary drying chamber comprising means capable of drying the film-like microporous film precursor, and thereby drying the film-like microporous film precursor while transporting the film-like microporous film precursor at a low speed until the film-like microporous film precursor is constrained by the movement mechanism of the drying chamber, makes it possible to convey the microporous film to the principal drying chamber in a state in which shrinkage of the film is minimized. In addition, conveying it at a low speed makes it possible to facilitate the task of constraining both widthwise edge parts of the film-like microporous film precursor using the constraining means of the movement mechanism.

In order to achieve the aforementioned object, the method for manufacturing a polyolefin microporous film according to one example of the present invention is a method for manufacturing a polyolefin microporous film in which a microporous film precursor obtained by mixing a polyolefin resin material and a plasticizer, is stretched into the form of a film and made into a strip-like and film-like microporous film precursor and a process for replacing the plasticizer with a solvent, followed by evaporating and drying the solvent in a drying chamber or a process for evaporating and drying the plasticizer in a drying chamber is performed; the method comprising: a step for mechanically constraining both widthwise edge parts of the strip-like and film-like microporous film precursor before the drying process; and a step for conveying the strip-like and film-like microporous film precursor into the drying chamber in a state in which both widthwise edge parts of the strip-like and film-like microporous film precursor are mechanically constrained and for heating the strip-like and film-like microporous film precursor being fed out, thereby causing the solvent or the plasticizer to evaporate from the strip-like and film-like microporous film precursor.

In the step for mechanically constraining both widthwise edge parts of the strip-like and film-like microporous film precursor before the drying process, both widthwise edge parts of the strip-like and film-like microporous film precursor are preferably mechanically constrained in a sealing liquid stored in a liquid sealing tank provided in order to separate the atmosphere in the drying chamber and the exterior atmosphere from each other.

According to a method of such description, since both widthwise edge parts of the film-like microporous film precursor are mechanically constrained, the film-like microporous film precursor can be prevented from creasing.

Mechanically constraining both widthwise ends of the strip-like and film-like microporous film precursor eliminates the risk of the film-like microporous film precursor contracting widthwise even when the film-like microporous film precursor is dried, makes it possible to perform conveying at a high speed and drying at a high temperature, and achieve high-speed continuous productivity. Since no widthwise shrinkage takes place during drying, the permeability does not decrease, and the uniformity in quality can also be enhanced.

It is preferable that before the step for mechanically constraining both widthwise edge parts of the strip-like and film-like microporous film precursor before the drying process, a step for causing the solvent or the plasticizer to evaporate from the strip-like and film-like microporous film precursor in a preliminary drying chamber provided at a stage prior to the drying chamber and a step for conveying the strip-like and film-like microporous film precursor from the preliminary drying chamber to the drying chamber are performed, and after the step for mechanically constraining both widthwise edge parts of the strip-like and film-like microporous film precursor, the drying process in the preliminary drying chamber is discontinued and the conveying speed of the drying device as a whole is increased.

Thus, during preliminary drying in the preliminary drying chamber, the strip-like and film-like microporous film precursor is transported at a low speed, whereby the microporous film can be conveyed into the principal drying chamber in a state in which shrinkage of the film is suppressed. In addition, conveying it at a low speed makes it possible to facilitate the task of constraining both widthwise edge parts of the film-like microporous film precursor using the movement mechanism.

In the drying chamber, the strip-like and film-like microporous film precursor is preferably conveyed upwards in a state in which both widthwise edge parts of the strip-like and film-like microporous film precursor are mechanically constrained.

Conveying the film-like microporous film precursor upwards makes it easier to mechanically constrain both widthwise edge parts of the film-like microporous film precursor without causing the film-like microporous film precursor to shrink, and makes it possible to downwardly wash off and efficiently remove the seal liquid adhering to the obverse and reverse surfaces of the film-like microporous film precursor.

Another possible mode is a method for manufacturing a polyolefin microporous film in which a microporous film precursor obtained by mixing a polyolyefin resin material and a plasticizer is stretched into the form of a film and made into a strip-like and film-like microporous film precursor, and the continuously conveyed film-like microporous film precursor is subjected to a process for replacing the plasticizer with a solvent, followed by evaporating and drying the solvent in a drying chamber; the method including: a step for mechanically constraining both widthwise edge parts of the strip-like and film-like microporous film precursor at an entrance side of the drying chamber; a step for commencing extraction of the plasticizer from the film-like microporous film precursor using a solvent in an extraction solvent tank disposed upstream of the drying chamber; and a step for conveying the strip-like and film-like microporous film precursor into the drying chamber and for heating the strip-like and film-like microporous film precursor being conveyed, thereby causing the solvent to evaporate from the strip-like and film-like microporous film precursor; the extraction of the plasticizer being commenced in the extraction solvent tank after both widthwise edge parts of the strip-like and film-like microporous film precursor are mechanically constrained at the entrance side of the drying chamber.

A method of such description makes it possible to perform conveying at a high speed and drying at a high temperature without causing the film-like microporous film precursor to crease, and achieve high-speed continuous productivity. Since no widthwise shrinkage takes place during drying, the permeability does not decrease, and the uniformity of quality can also be enhanced.

### Effect of the Invention

The present invention makes it possible to obtain a device and method for manufacturing a polyolefin microporous film in which it is possible to minimize shrinkage of the polyolefin microporous film during the drying process and to enhance uniformity of quality, thereby achieving high-speed continuous productivity.

### BEST MODE FOR CARRYING OUT THE INVENTION

An embodiment of the device and method for manufacturing a polyolefin microporous film will now be described with reference to the drawings.

A microporous film obtained by the present invention refers to a porous sheet or film substantively made from a polyolefin, and is used, e.g., as a cell material such as a separator. There are no particular limitations on the format of the cell, and the microporous film is suitable, e.g., for cylindrical cells, as well as rectangular cells, thin cells, button cells, and electrolytic capacitors, etc.

In one embodiment of the present invention, a microporous film refers to what is obtained as a result of performing a predetermined drying process on a film-like porous precursor, and the item being processed whether during or before the drying process is referred to as a “microporous film precursor.”

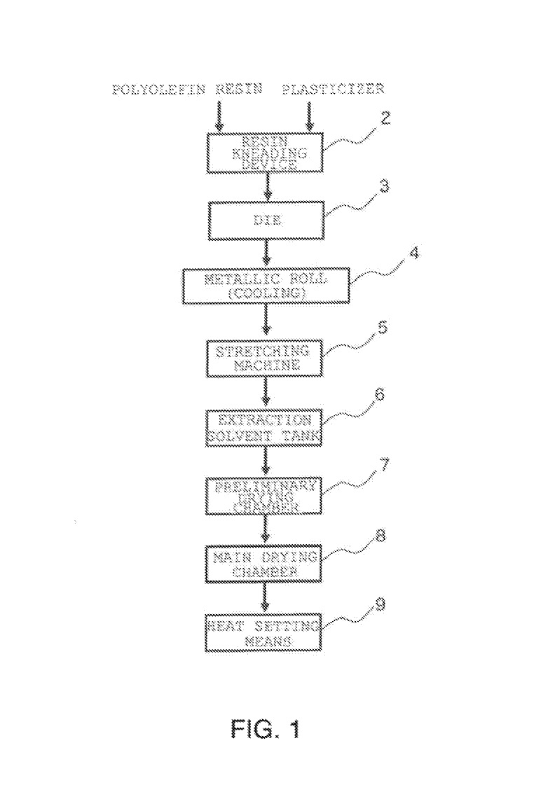

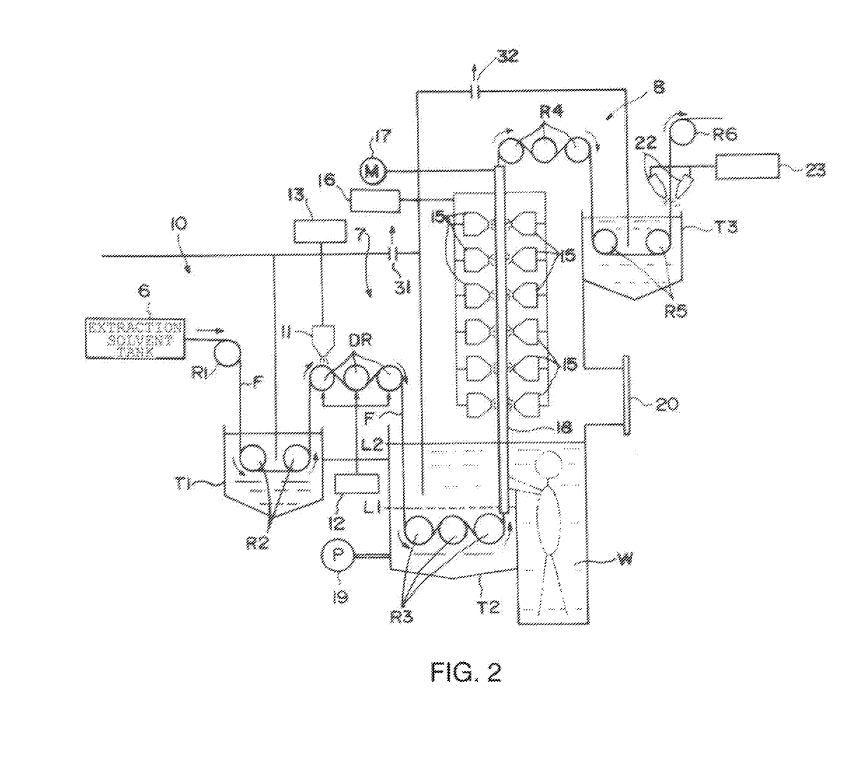

FIG. 1 is a block diagram showing the schematic configuration of a device for manufacturing a polyolefin microporous film according to one example of the present invention (hereafter referred to as a microporous film manufacturing device). FIG. 2 is a cross-section view schematically showing the partial configuration of FIG. 1.

As shown in FIG. 1, the microporous film manufacturing device 1 comprises: a resin kneading device 2 for mixing a polyolefin resin material (e.g., ethylene) and a plasticizer (e.g., liquid paraffin) and obtaining a mixture solution; and a die 3 through which the mixture solution obtained by the resin kneading device 2 is extruded into the form of a sheet.

The microporous film manufacturing device 1 also comprises: a metallic roll 4 for cooling and solidifying the sheet-like mixture solution extruded through the die 3 and obtaining a sheet-like microporous film precursor; and a stretching machine 5 for stretching the obtained sheet-like microporous film precursor in at least one axial direction and obtaining a strip-like and film-like microporous film precursor (hereafter referred to as a film-like microporous film precursor).

The device also comprises: an extraction solvent tank 6 for extracting the plasticizer from the strip-like and film-like microporous film precursor; and a preliminary drying chamber 7 and a main drying chamber 8 for drying, by evaporation, the solvent adhered to the film-like microporous film precursor pulled out from the extraction solvent tank 6. The device is further provided with a thermo-setting means 9 for applying a predetermined heating process on the strip-like microporous film obtained by the drying process, and performing heat setting.

Although not shown, the device may also be provided with a stretching machine for performing stretching in at least one axial direction before, after, or during the heating process in relation to performing the heat setting process.

In the resin kneading device 2, the plasticizer is added at an arbitrary ratio and mixed while the polyolefin resin material is caused to melt by heating, thereby generating a uniform mixture solution. For the resin kneading device 2, any of a unidirectional rotary twin-screw extruder, a multi-screw kneading machine, a single-screw extruder, a drum mixer and the like, which belong to the category of a multi-screw extruder, can be used.

The polyolefin resin material before melting by heating may be in the form of a powder, granules, or pellets. The plasticizer may be in the form of a solid or a liquid at room temperature, but is preferably in the form of a liquid.

When the polyolefin resin material and the plasticizer are melt-kneaded, the polyolefin resin material and the plasticizer may be separately supplied to the resin kneading device 2, or the polyolefin resin material and the plasticizer may be mixed and caused to disperse at room temperature and thus obtained mixture composition may be supplied to the resin kneading device 2 such as an extruder.

A T-die may be used as the die 3; this makes it possible to extrude a sheet-like mixture solution.

The sheet-like mixture solution extruded through the die 3 comes into contact with the metallic roll 4 and thereby being cooled to a temperature less than the crystallization temperature of the resin and turned into a sheet-like microporous film precursor.

Other than the method in which the metallic roll 4 is used as the means for cooling the sheet-form mixture solution, water, air, the plasticizer, or another medium may be used as a heat conductor.

The mixture solution may be extruded into the form of a sheet using a T-tie as the die 3: however, this is not provided by way of limitation, and it may be extruded into a cylindrical shape using, e.g., a circular die, followed by slicing open the cylinder into the form of a sheet.

The stretching machine 5 stretches the sheet-like microporous film precursor at least one time in at least one axial direction. “At least one axial direction” includes any of uniaxial stretching in the machine direction, uniaxial stretching in the width direction, simultaneous biaxial stretching, and sequential biaxial stretching. “At least once” represents any of single-stage stretching, multi-stage stretching, and multiple stretching.

The stretching temperature is preferably no less than a temperature that is 50° C. cooler than the melting point of the polyolefin microporous film (referred to as Tm), and less than Tm; and is further preferably no less than a temperature that is 40° C. cooler than Tm, and less than a temperature that is 5° C. cooler than Tm.

This is because a stretching temperature of less than a temperature that is 50° C. cooler than Tm will result in the stretching performance being poorer, the distortion component after stretching remaining, and the dimensional stability at a high temperature decreasing, and is therefore not preferable. A temperature equal to or greater than Tm° C. will result in the microporous film melting and the permeation performance being lost, and is therefore not preferable. The stretching magnification can be set to an arbitrary magnification; however, the magnification in the uniaxial direction is preferably 2 to 20 and further preferably 4 to 10, and the area magnification in the biaxial direction is preferably 2 to 400 and further preferably 4 to 400. Biaxial stretching is preferred in order to obtain a high strength.

The extraction solvent tank 6 is used to extract the plasticizer from the film-like microporous film precursor stretched and formed into the form of a strip by the stretching machine 5.

The extraction solvent tank 6 is filled with an extraction solvent comprising, e.g., n-hexane, and the film-like microporous film precursor F formed into the form of a strip by the stretching machine 5 is conveyed into the extraction solvent tank 6. Since a large amount of the solvent volatilizes from the extraction solvent tank 6, the extraction solvent tank 6 is housed in a plasticizer extraction chamber 10 shown in FIG. 2. The film-like microporous film precursor F placed in the extraction solvent tank 6 is immersed in the tank for sufficient time to extract the plasticizer, and then conveyed from the tank.

A roll R1, which rotates at a predetermined speed around a shaft, is provided as a mechanism for conveying the film-like microporous film precursor F from the extraction solvent tank 6. Specifically, the film-like microporous film precursor F is stretched around the roll R1, and conveyed in a state in which a predetermined tension is maintained.

The interior of the extraction solvent tank 6 may also, e.g., be divided into multiple stages and a concentration difference provided between each of the tanks, and the film-like microporous film precursor F may be sequentially conveyed into each of the tanks (multi-stage method). Alternatively, the extraction solvent may be supplied from the opposite direction to that in which the film-like microporous film precursor F is conveyed, with a concentration gradient being provided (counter current method), whereby the plasticizer can be extracted at a higher extraction efficiency.

Heating the extraction solvent to a temperature less than the boiling point of the solvent will accelerate diffusion between the plasticizer and the solvent, making it possible to increase the extraction efficiency, and is therefore further preferable.

As shown in FIG. 2, the plasticizer extraction chamber 10 and the preliminary drying chamber 7 are separated by the liquid seal tank T1 in which, e.g., water is stored as a sealing liquid. The solvent which volatilized in the extraction solvent tank 6 is thereby prevented from entering the preliminary drying chamber 7. A roll R2, representing a conveying means, is provided in the liquid seal tank T1, and the film-like microporous film precursor F is extended around the roll R2. Specifically, the film-like microporous film precursor F conveyed from the plasticizer extraction chamber 10 is passed through the water in the liquid seal tank T1 and transported into the preliminary drying chamber 7; therefore, the atmosphere in the extraction solvent tank 6 and the atmosphere in the preliminary drying chamber 7 are completely separated from each other.

The preliminary drying chamber 7 is equipped with: drying rolls DR functioning as means for conveying the film-like microporous film precursor F; and an air blow nozzle 11 (means capable of drying the film-like microporous film precursor F) capable of blasting air, nitrogen, or another gas onto the surface of the film-like microporous film precursor F conveyed by the drying rolls DR. The drying rolls DR are formed to a cylindrical shape, and are formed so as to have an axial length that is greater than the width dimension of the film-like microporous film precursor F. The air blow nozzle 11 has, e.g., a slit nozzle extending in the width direction of the film-like microporous film precursor F in order to supply a gas flow for dispersing solvent vapors generated at the surface of the film-like microporous film precursor F.

There is no particular requirement for the drying rolls DR to have a function of heating the film-like microporous film precursor F; however, the drying rolls DR may be configured so as to be capable of being heated by circulating a heated heat medium in the roll or directly heating the roll by, e.g., induction heating.

The air blow nozzle 11 need only be capable of blasting air or an inert gas such as nitrogen at a predetermined temperature (e.g., room temperature), but preferably has a function capable of supplying a gas at a desired temperature using, e.g., a heat exchanger.

When the drying rolls DR and the air blow nozzle 11 function as a drying means in a preliminary drying chamber 7 of such description, the majority of the solvent adhering to the obverse and reverse surfaces of the film-like microporous film precursor F evaporates by the heating and dispersing actions of the gas blown from the air blow nozzle 11 while the film-like microporous film precursor F is conveyed by the drying rolls DR.

In addition, when the drying rolls DR and the air blow nozzle 11 function as a drying means in the preliminary drying chamber 7, the conveying is controlled so that the conveying speed is low (e.g., 5 m/min) so that the strip-like and film-like microporous film precursor F does not contract widthwise.

The preliminary drying chamber 7 and the main drying chamber 8 are separated by a liquid seal tank T2 in which, e.g., water is stored as a sealing liquid. A plurality of rolls R3 are provided in the liquid seal tank T2 as a conveying means. The film-like microporous film precursor F conveyed from the preliminary drying chamber 7 is passed through the water and transported into the main drying chamber 8. The atmosphere in the preliminary drying chamber 7 and the atmosphere in the main drying chamber 8 are thereby completely separated from each other.

A tenter 18 (movement mechanism) for conveying the film-like microporous film precursor F vertically upwards by being driven by a motor 17 in a state of securing, by fixing, both edge parts of the film-like microporous film precursor F and mechanically constraining both widthwise edges of the film-like microporous film precursor F so that the film-like microporous film precursor F does not contract widthwise is provided in the main drying chamber 8, above the liquid seal tank T2. A tenter for holding both edge parts of the film by, e.g., grips can be preferably used as the tenter 18.

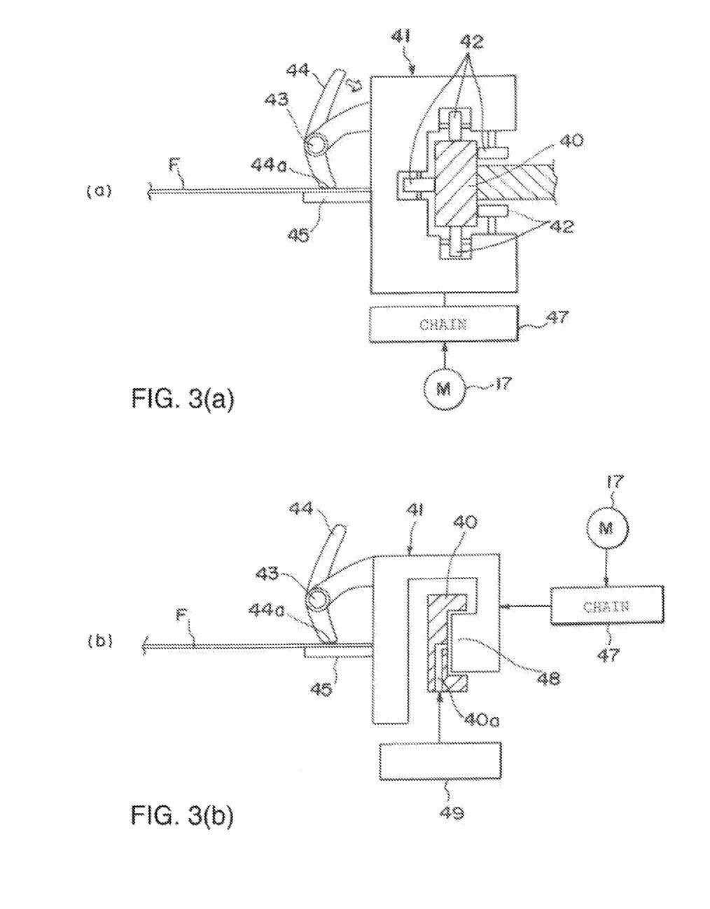

Specifically, a pair of rails 40 (with FIG. 3(a) showing the cross-section of one of the rails) extending vertically from the liquid seal tank T2 to the upper part of the main drying chamber 8 are provided. As shown in the cross-section view in FIG. 3(a), a plurality (only one is shown in the drawing) of tenter clips 41 are arranged in parallel along the rails 40. The tenter clips 41 are provided so as to engage with a chain 47, and are configured so as to be moved upwards along a rail 40 by the chain 47 being driven by the motor 17.

As shown in FIG. 3(a), each of the tenter clips 41 is provided with a plurality of bearings 42. The bearings 42 roll on the rail 40, whereby the tenter clip 41 moves along the rail 40.

The tenter clip 41 is provided with a lever 44 capable of turning about a rotation shaft 43. Turning the lever 44 in the direction indicated by an arrow causes the lever lower end part 44a to secure, by holding, a side edge part of the film-like microporous film precursor F placed on a clip platform 45.

The lower part of the tenter 18 is disposed at a position that is lower than the water level L1 of the sealing liquid stored in the liquid seal tank T2, and the lower part of the tenter 18 is in a state of being immersed in the sealing liquid. Therefore, the tenter 18 is required to be corrosion-resistant and water-resistant, and, e.g., most of the tenter 18, such as the rails 40, is formed from stainless steel (SUS).

A configuration in which no lubricant oil is used is preferred in the main drying chamber 8 and the liquid seal tank T1; therefore, the bearings 42 and the chain 47 are preferably made from a self-lubricating material that produces little dust due to friction. Therefore, in the present embodiment, a composite material comprising a solid lubricant and a metal is used as the material forming the bearings 42. More specifically, a solid lubricant is arranged, as a retainer, between balls made from, e.g. SUS or another metal or a ceramic. For the solid lubricant, e.g., a sintered material made from graphite, boron nitride, and a nickel alloy can be used; however, this is not provided by way of limitation. Another example of the solid lubricant is using any of MoS2 (molybdenum disulfide), WS2 (tungsten disulfide), and TaS2 (tantalum disulfide). NF-Metal™ (Fuji Die) can be used as the composite material comprising a solid lubricant and a metal.

As described above, each of the tenter clips 41 is configured so as to move along a rail 40 with a plurality of bearings 42 interposed therebetween. However, the configuration is not limited to that described; in another possible configuration each of the tenter clips 41 is capable of sliding along the rail 40 as shown in FIG. 3(b).

In other words, in such an instance, the tenter clip 41 is configured to have a slide member 48 provided so as to be capable of sliding against the rail 40. The chain 47 being driven by the motor 17 in this configuration moves the slide member 48 (tenter clip 41) upwards along the rail 40.

In such an instance, means for supplying, e.g., water as a lubricant (lubricant supply source 49, lubricant supply path 40a, etc.) to the sliding surface between the rail 40 and the slide member 48 is preferably provided.

Alternatively, it is further preferable to form either the rails 40 or the slide member 48 from a composite material comprising a solid lubricant and a metal, thereby making it possible to further suppress frictional resistance during movement. For the solid lubricant, e.g., a sintered material made from graphite, boron nitride, and a nickel alloy can be used; however, this is not provided by way of limitation. Another example of the solid lubricant is using any of MoS2 (molybdenum disulfide), WS2 (tungsten disulfide), and TaS2 (tantalum disulfide). NF-Metal™ (Fuji Die) can be used as the composite material comprising a solid lubricant and a metal.

As described above, the tenter 18 conveys the film-like microporous film precursor F vertically upwards; therefore, it becomes easier to secure, by holding, both widthwise edge parts of the film-like microporous film precursor F without causing the film-like microporous film precursor F to contract, and moisture adhering to the obverse and reverse surfaces of the film-like microporous film precursor F is efficiently removed.

In the section in which the tenter 18 conveys the film-like microporous film precursor F vertically upwards, a plurality (12 in the drawing) of air blow nozzles 15 representing a drying means are arranged, e.g., at regular intervals, along the conveying direction (vertical direction).

Each of the air blow nozzles 15 has a slit-shaped nozzle port extending in the width direction of the film-like microporous film precursor F, and the air blow nozzles 15 are oriented in a bilaterally symmetric arrangement so that hot air is blown onto each of the obverse and reverse surfaces of the film-like microporous film precursor F. Each of the air blow nozzles 15 is configured as to be driven by a hot airflow supply unit 16 to blasting a hot airflow having a predetermined temperature (e.g. 100° C.).

The water level in the liquid seal tank T2 can be changed in two stages using a water supply/discharge pump 19, and can be set to a lower water level L1 used during the preparation step before the drying process using the main drying chamber 8 is commenced, and a higher water level L2 used during the main drying step.

Specifically, during the preparation step, the film-like microporous film precursor F conveyed at low speed from the preliminary drying chamber 7 is passed through the water which is at water level L1 and transported to the lowermost part of the tenter 18, and a worker is able to enter a working space W in the liquid seal tank T2.

As described above, the lower part of the tenter 18 is disposed at a position lower than water level L1; therefore, it is possible for the worker in the working space W to perform the task of introducing (the obverse and reverse surfaces of) the left and right edge parts of the film-like microporous film precursor F into the tenter 18 in ambient air. After the task is complete, the water level is raised to L2, whereby the film-like microporous film precursor F is securely held by the tenter clips 41 in the water. It is thereby possible for both edges of the film-like microporous film precursor F to be mechanically constrained without creasing occurring in the film-like microporous film precursor F.

The configuration is such that the worker can enter and exit from an entrance/exit 20 provided to the side wall of the main drying chamber 8.

A plurality (three in the drawing) of rolls R4 for conveying the microporous film F produced by the drying process in the main drying chamber 8 are provided above the tenter 18. The main drying chamber 8 is separated from the exterior, on the downstream side with regards to the processing step, by a liquid seal tank T3 storing, e.g., water as a sealing liquid. A plurality (two in the drawing) of rolls R5 representing a conveying means are provided in the water in the liquid seal tank T3. Specifically, the film-like microporous film precursor F, which is conveyed vertically upwards by the tenter 18, is subjected to hot airflow from the air blow nozzles 15 causing the solvent to evaporate from the interior of the film-like microporous film precursor F, turned into a microporous film F, and then conveyed into the liquid seal tank T3 by the rolls R4. The configuration is such that it is then passed through the water and conveyed to the exterior by the rolls R5.

A roll R6 representing a conveying means is provided above the liquid seal tank T3, and a pair of air blow nozzles 22 for blowing air having a predetermined temperature onto the obverse and reverse surfaces of the microporous film F are provided in front of the roll R6. Each of the air blow nozzles 22 is configured to be driven by an air supply unit 23 to blast air having a predetermined temperature from a slit-shaped nozzle. Air from the air blow nozzles 22 is blown onto the obverse and reverse surfaces of the microporous film F, whereby any moisture adhering in the liquid seal tank T3 is removed.

An exhaust pipe 31 and an exhaust pipe 32 connected to an exhaust pump (not shown) are provided to the preliminary drying chamber 7 and the main drying chamber 8, respectively. The exhaust pumps are driven when the drying process in the preliminary drying chamber 7 or the drying process in the main drying chamber 8 is being performed, and are configured to discharge the atmosphere in the respective chamber through the exhaust pipe 31, 32.

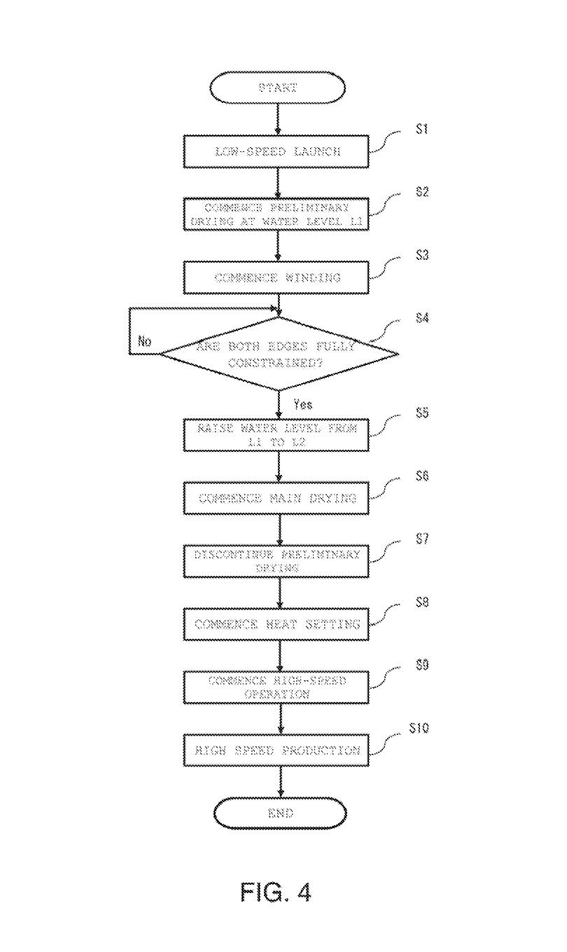

Next, the series of steps in the microporous film manufacturing device 1 configured as described above will be described with reference to the flow chart shown in FIG. 4.

When a polyolefin microporous film is manufactured, steps corresponding to low-speed launch are initially performed (step S1 in FIG. 4) in order to obtain a film-like microporous film precursor F. Specifically, to begin with, a polyolefin resin material comprising, e.g., ethylene, and a plasticizer comprising, e.g., liquid paraffin, are placed in the resin kneading device 2, and a mixture solution is obtained.

The mixture solution obtained by the resin kneading device 2 is extruded as a sheet-like mixture solution through the die 3.

The sheet-like mixture solution extruded through the die 3 comes into contact with the roll surface of the cylindrical metallic roll 4 and is thereby caused to cool and solidify, and turned into a sheet-like microporous film precursor.

The sheet-like microporous film precursor is stretched in at least one axial direction by the stretching machine 5, and turned into a strip-like and film-like microporous film precursor F having a predetermined thickness. The film-like microporous film precursor F is formed so as to have one film thickness between 1 to 500 μm, and further preferably 5 to 100 μm. A film thickness of less than 1 μm results in insufficient mechanical strength. A film thickness greater than 500 μm results in an increase in the volume occupied by the separator, and therefore is disadvantageous in terms of increasing the capacity of the cell and is not preferable.

The resulting film-like microporous film precursor F is transported into the plasticizer extraction chamber 10 and immersed for a predetermined time in the extraction solvent in the extraction solvent tank 6, and the plasticizer is extracted.

Then, the strip-like and film-like microporous film precursor F obtained by step S1 is continuously conveyed into the preliminary drying chamber 7 through the liquid seal tank T1 as shown in FIG. 2, and in the preliminary drying chamber 7, is conveyed by the drying rolls DR at a low speed (e.g., 5 m/s) so that widthwise shrinkage does not occur. A gas having a predetermined temperature (e.g., 20° C.) is blown from the air blow nozzle 11 onto the surface of the film-like microporous film precursor F, whereby the solvent gradually evaporates from the interior of the film-like microporous film precursor F, and the preliminary drying process is commenced (step S2 in FIG. 4). At this time, the liquid seal tank T2 contains water up to water level L1.

While the preliminary drying process is commenced, a winding means (not shown) begins to wind up the tip of the film-like microporous film precursor F (step S3 in FIG. 4), and the film-like microporous film precursor F is conveyed, still at a low speed, from the preliminary drying chamber 7 to the liquid seal tank T2.

As mentioned above, the liquid seal tank T2 contains water up to water level L1, and a worker having entered the tank through the entrance/exit 20 is standing by at a predetermined position, or more specifically, in the vicinity of the lower part of the tenter 18 (working space W). Then, the worker introduces, in the water stored in the tank, the left and right edge parts of the film-like microporous film precursor F conveyed by the rolls R3 into the tenter 18 (step S4 in FIG. 4).

Since the film-like microporous film precursor F is conveyed at a low speed in this step, the worker can perform the task with ease, and the left and right edge parts of the film-like microporous film precursor F is reliably secured, by being held, by the tenter clips 41.

Once the left and right edge parts of the film-like microporous film precursor F are mechanically constrained by the tenter 18 at the entrance side of the main drying chamber 8 as described above, the worker leaves through the entrance/exit 20, and the tank is filled to water level L2 (step S5 in FIG. 4).

The film-like microporous film precursor F having the left and right edge parts mechanically constrained by the tenter clips 41 of the tenter 18 is conveyed into the main drying chamber 8.

In the main drying chamber 8, the film-like microporous film precursor F having the left and right edge parts mechanically constrained by the tenter clips 41 of the tenter 18 is driven by the motor 17 to be continuously conveyed vertically upwards, and hot air having a predetermined temperature (e.g., 100° C.) is blown from the air blow nozzles 15 onto the obverse and reverse surfaces of the film-like microporous film precursor F. The main drying process is thereby commenced, and the solvent included in the interior of the film-like microporous film precursor F is dried by evaporation (step S6 in FIG. 4).

Once the main drying process is commenced, in the preliminary drying chamber 7, the supply of air from the air blow nozzle 11 and the exhaust discharge through the exhaust pipe 31 are discontinued. Then, once the solvent concentration in the preliminary drying chamber 7 has increased and it has been confirmed that the evaporation of the solvent from the surface of the film-like microporous film precursor F has stopped, heating of the drying rolls DR is discontinued (step S7 in FIG. 4).

After the drying process in the preliminary drying chamber 7 has been discontinued, a heat setting process, in which a predetermined heat treatment is applied to the microporous film F formed by the drying process, is commenced (step S8 in FIG. 4). The microporous film F may be stretched again in at least one axial direction before or after heat setting, or during heating for heat setting. Alternatively, the heat setting and/or the repeat stretching may be performed by a machine formed so as to be structurally integral with the main drying device.

Once the operation of the preliminary drying chamber 7 has been discontinued, the production speed of the microporous film manufacturing device 1 as a whole is increased to a high speed (e.g., a drying device conveying speed of 100 m/s) (step S9 in FIG. 4).

In the drying process performed in the main drying chamber 8, the film-like microporous film precursor F is subjected to a drying process in a state in which the left and right edge parts thereof are secured by being held (mechanically constrained), and therefore, there is no risk of the film-like microporous film precursor F contracting widthwise. It is therefore possible to achieve a high drying process speed (high-speed production) (step S10 in FIG. 4). In addition, since the film-like microporous film precursor F is conveyed vertically upwards from the liquid seal tank T2, the moisture adhering to the obverse and reverse surfaces thereof is readily removed.

Thus, the solvent is caused to evaporate from the interior of the film-like microporous film precursor F, which has been conveyed at a high speed to the upper part of the main drying chamber 8 by the tenter 18, and the film-like microporous film precursor F is turned into the microporous film F and conveyed into the liquid seal tank T3 from the main drying chamber 8 by the rolls R4.

The microporous film F passing through the liquid seal tank T3 is conveyed vertically upwards out of the tank by the rolls R5, R6, subjected to air blown onto the obverse and reverse surfaces by the air blow nozzles 22, and dried.

As described above, according to one embodiment of the present invention, both widthwise edges (left and right edges) of the strip-like and film-like microporous film precursor F conveyed at a low speed into the main drying chamber 8 are secured, by being held, by the tenter 18 in the water stored in the liquid seal tank T2. In a state in which both widthwise edges of the film-like microporous film precursor F are secured by being held, the film-like microporous film precursor F is conveyed vertically upwards at a high speed, hot air is blown onto the obverse and reverse surfaces, and drying is performed.

Specifically, since both widthwise edge parts of the film-like microporous film precursor F are secured, by being held, by the tenter 18 in the water, both widthwise edge parts can be mechanically constrained in a state in which no creasing occurs in the film-like microporous film precursor F. In addition, mechanically constraining both of the widthwise edge parts of the film-like microporous film precursor F makes it possible to eliminate the risk of shrinkage in widthwise even when hot air is blown onto the obverse and reverse surfaces of the film-like microporous film precursor F, perform conveying at a high speed and drying at a high temperature, and obtain a high-speed continuous productivity. In addition, since no widthwise shrinkage takes place during the drying process, the permeability does not decrease, and the uniformity of quality can also be enhanced.

In the aforementioned embodiment, a description was given for a tenter 18 as an example of the movement mechanism; however, the configuration is not limited to that described, and a configuration other than a tenter can also be used as long as it can be transported in a state in which both widthwise edges of the film-like microporous film precursor are mechanically constrained.

In the aforementioned embodiment, both of the widthwise edge parts of the film-like microporous film precursor F are secured, by being held, in the water, whereby both of the widthwise edge parts are mechanically constrained in a state in which no creasing occurs in the film-like microporous film precursor F. However, the present invention is not limited to this format. Specifically, both widthwise edge parts may be secured by being held in air (instead of in the water) as long as both widthwise edge parts can be mechanically constrained in a state in which no creasing occurs in the film-like microporous film precursor F.

In the aforementioned embodiment, the plasticizer is extracted from the film-like microporous film precursor F using the extraction solvent tank 6 disposed upstream from the main drying chamber 8, after which both edge parts of the film-like microporous film precursor F are secured, by being held, by the tenter 18 on the entrance side of the main drying chamber 8.

However, the present invention is not limited to this configuration; for example, the microporous film F can be produced according to the following procedure.

Initially, the extraction solvent tank 6 is put in a state of not containing the solvent, or the extraction of the plasticizer in the extraction solvent tank 6 is otherwise prevented from taking place; and the pre-extraction film-like microporous film precursor F is conveyed into the main drying chamber 8 at a low speed. Then, both edges of the pre-extraction film-like microporous film precursor F are secured, by being held, by the tenter 18. Extraction of the plasticizer in the extraction solvent tank 6 filled with a solvent, and drying in the main drying chamber 8, are subsequently commenced. Then, the conveying speed is increased, and high-speed production is performed.

The effect of the present invention can still be sufficiently obtained according to a procedure of such description.

In the aforementioned embodiment. e.g., ethylene is used as the polyolefin resin material. However, other than ethylene, it is also possible to use a homopolymer or a copolymer of propylene, 1-butene, 4-methyl-1-pentene, 1-hexene, and 1-octene. Polyolefins selected from the aforementioned group of homopolymers and copolymers can be mixed for use. Representative examples of the polymer include low-density polyethylene, linear low-density polyethylene, medium-density polyethylene, high-density polyethylene, ultrahigh molecular weight polyethylene, isotactic polypropylene, atactic polypropylene, syndiotactic polypropylene, polybutene, polymethylpentene, and ethylene propylene rubber. In an instance in which the microporous film obtained using the manufacturing method of the present invention is used as a cell separator, it is particularly preferable to use a resin having high-density polyethylene as a principal component in terms of the properties requirement for the resin to have a low melting point and a high strength.

In the aforementioned embodiment, liquid paraffin was indicated as an example of the plasticizer. However, this is not provided by way of limitation. Any solvent capable of forming a uniform solution at a temperature equal to or greater than the melting point of the polyolefin resin when mixed with the polyolefin resin can be used. Examples other than liquid paraffin include hydrocarbons such as paraffin wax and decalin, esters such as dibutyl phthalate and dioctyl phthalate, and higher alcohols such as stearyl alcohol and oleyl alcohol.

The requirement for the ratio between the polyolefin resin and plasticizer used in the present invention is that the ratio must be sufficient for microphase separation to occur and for a sheet-like microporous film precursor to be capable of forming, and be of a degree in which productivity is not lost. Specifically, the weight ratio of the polyolefin resin in the composition comprising the polyolefin resin and a plasticizer is preferably 5 to 70% and further preferably 10 to 60%. If the weight ratio of the polyolefin resin is less than 20%, the melt tension during melt forming will be insufficient, and formability will be poor. Although the invention can be carried out with a polyolefin weight ratio of less than 5%, in such an instance, there will be a need to add a large amount of ultrahigh molecular weight polyolefin in order to increase the melt tension, reducing uniform dispersion performance; therefore, such a ratio would not be preferable.

In the aforementioned embodiment, n-hexane is used as an example of a plasticizer extraction solvent (M1); however, this is not provided by way of limitation. What is a good solvent of the plasticizer and has a boiling point lower than the melting point of the polyolefin microporous film can be suitably used. Examples of an extraction solvent other than n-hexane include hydrocarbons such as cyclohexane, halogenated hydrocarbons such as methylene chloride and 1,1,1-trichloroethane, alcohols such as ethanol and isopropanol, ethers such as diethyl ether and tetrahydrofuran, ketones such as acetone and 2-butanon, and hydrofluoroethers.

When a microporous film is manufactured using the manufacturing method of the present invention, the air permeability of the microporous film is preferably 3000 seconds/100 cc/25 μm or less, and further preferably 1000 seconds/100 cc/25 μm or less. The air permeability is defined by the ratio between the air permeation time and the film thickness. An air permeability of greater than 3000 seconds/100 cc/25 μm will result in the ion permeability deteriorating or the pore diameter being extremely small, and is therefore not preferable in terms of permeability performance in either case.

When a microporous film is manufactured using the manufacturing method of the present invention, the porosity of the microporous film is preferably 20 to 80% and further preferably 30 to 70%. A porosity of less than 20% will result in insufficient ion permeability, represented by electrical resistance, and air permeability; and porosity greater than 80% will result in insufficient strength represented by puncture strength and tensile strength.

When a microporous film is manufactured using the manufacturing method of the present invention, the puncture strength of the microporous film is preferably equal to or greater than 300 g/25 μm, and further preferably equal to or greater than 400 g/25 μm. The puncture strength is defined by the ratio between the film thickness and the maximum load in a puncture test. A puncture strength of less than 300 g/25 μm will result in an increase in faults such as short circuit failure when the cell is wound, and is therefore not preferred.

### EXAMPLES

A further description will now be given for the method for manufacturing a polyolefin microporous film according to one example of the present invention with reference to examples. In the present examples, a polyolefin microporous film was manufactured on the basis of the aforementioned embodiment, and the effect of the present invention was verified. The properties of the polyolefin microporous film obtained in the present example were measured as follows.

(1) Film Thickness

Measured using a dial gauge (PEACOCK NO. 25; Ozaki Manufacturing).

(2) Air Permeability

The air permeability (seconds/100 cc/25 μm) was obtained through film thickness conversion according to the following relationship from the film thickness (μm) and the air permeation time (seconds/100 cc) obtained using a Gurley air permeability meter in accordance with JIS P-8117.

Air permeability=air permeation time×25/film thickness

(3) Puncture Strength

A puncture test was performed using a compression testing machine (KES-G5, Kato Tech) under the following conditions: needle tip curvature radius=0.5 mm; puncture speed=2 mm/sec. The puncture strength (g/25 μm) was obtained through film thickness conversion using the following relationship from the maximum puncture load (g) and the film thickness (μm).

Puncture strength=maximum puncture load×25/film thickness

### Example 1

The method for manufacturing a polyolefin microporous film according to one example of the present invention was performed under the following conditions. The states (shrinkage state, drying state) of the obtained microporous film were verified. Samples were taken from three locations of the obtained microporous film, i.e., the center part of the film and portions located 150 mm inward from left and right edges; and the properties of the samples were measured.

(1) Polyolefin Resin Material

A high-density polyethylene (weight-average molecular weight: 30,000, molecular weight distribution: 7; density: 0.956) and what is obtained by dry-blending the polyethylene with 0.3 weight parts of 2,6-di-t-butyl-p-cresol using a Henschel mixer were used.

(2) Plasticizer

Liquid paraffin was used (kinetic viscosity at 37.78° C.=75.9 cSt).

(3)

Resin Kneading Device

A 35 mm twin-screw extruder was used to perform melt-kneading on the polyolefin resin material and the plasticizer.

(4) Die

A coat-hanger die was used.

(5) Metal Roll

It was extruded onto a cooling roll in which the surface temperature is controlled to 40° C., and a sheet-like microporous film precursor having a thickness of 1.1 mm was obtained. The ratio of the composition was controlled so as to contain 70 weight parts of liquid paraffin relative to 30 weight parts of polyethylene.

(6) Stretching Machine

A tenter-type biaxial stretching machine was used. The obtained sheet-like microporous film precursor was stretched using a tenter-type simultaneous biaxial stretching machine to a magnification of 5×5 at 119° C.

(7) Extraction Solvent Tank

Methylene chloride was used as the extraction solvent, the film-like microporous film precursor was immersed therein, and the plasticizer (liquid paraffin) was removed by extraction.

(8) Drying

As with the preliminary drying chamber 7 in FIG. 2, three hot rolls and one warm-air nozzle were used to perform drying, with the film-like microporous film precursor conveyed at a speed of 5 m/min and the warm air at a temperature of 20° C., and the film-like microporous film precursor was held by the clips of the tenter in the main drying chamber. The blowing of hot airflow having a temperature of 80° C. onto the obverse and reverse surfaces of the film-like microporous film precursor was commenced while conveying the strip-like and film-like microporous film precursor vertically upwards using the tenter. Once the supply of warm air into the preliminary drying chamber was stopped and it was confirmed that drying of the film-like microporous film precursor in the preliminary drying chamber has been discontinued, the speed of the microporous film manufacturing device was increased, and the film conveying speed in the main drying chamber was raised to 100 m/min.

(9) Heat Setting

The microporous film obtained by the drying process was subjected to a heating process at 125° C. for 60 seconds, and subjected to heat setting.

### Example 2

For the example 2, the experiment was performed in a similar manner to the first example, with the exception of the ratio of the composition of the sheet-like microporous film precursor being adjusted to 85 weight parts of liquid paraffin relative to 15 weight parts of polyethylene, and a final film conveying speed in the main drying chamber of 50 m/min being used.

### Comparative Example 1

For comparative example 1, according to the preliminary drying process in the example 1, the film-like microporous film precursor is conveyed at a speed of 10 m/min, a hot airflow of predetermined temperature (50° C.) is blown onto the surface of the film-like microporous film precursor on a roll heated to a predetermined temperature (40° C.), whereby the main drying process was performed.

### Comparative Example 2

For Comparative Example 2, the experiment was performed in a similar manner to comparative example 1, except that the film-like microporous film precursor was conveyed at a speed of 20 m/min.

The assessment results of the states (shrinkage state, drying state) of the microporous film are shown in table 1 as the results for the example 1 and example 2 and comparative example 1. In table 1, 1 represents “good in entire film”, 2 represents “some defects”, and 3 represents “significant defects”.

TABLE 1

| | Shrinkage state | Drying state |
|---|---|---|
| Example 1 | 1 | 1 |
| Example 2 | 1 | 1 |
| Comparative Example 1 | 2 | 1 |
| Comparative Example 2 | 3 | 3 |

With regards to the measurements of properties of the microporous films, results for the example 1 are shown in table 2, results for the example 2 are shown in table 3, and results for comparative example 1 are shown in table 3.

TABLE 2
Example 1

| | Left edge | Center | Right edge | σ |
|---|---|---|---|---|
| Film thickness | 24.5 | 24.8 | 25.1 | — |
| Air permeability | 348 | 362 | 355 | 24 |
| Puncture strength | 631 | 618 | 625 | 13 |

TABLE 3
Example 2

| | Left edge | Center | Right edge | σ |
|---|---|---|---|---|
| Film thickness | 20.9 | 20.1 | 19.7 | — |
| Air permeability | 185 | 174 | 173 | 12 |
| Puncture strength | 433 | 427 | 424 | 9 |

TABLE 4
Comparative example 1

| | Left edge | Center | Right edge | σ |
|---|---|---|---|---|
| Film thickness | 26.8 | 25.3 | 28.1 | — |
| Air permeability | 632 | 443 | 714 | 271 |
| Puncture strength | 447 | 533 | 421 | 112 |

As shown in table 1, the states of the microporous film obtained in the examples 1 and 2 were satisfactory in both cases. In contrast, in comparative example 1, the drying state was satisfactory, but shrinkage was observed. In comparative example 2, the drying state was poor, with an undried portion remained at the exit of the drying chamber, and overall widthwise shrinkage was observed.

As shown in tables 2 and 3, satisfactory and uniform values were obtained with regards to the properties of the microporous film obtained in the examples 1 and 2. In contrast, as seen in table 4, in comparative example 1, the properties of the microporous film were poorer and lacked uniformity.

The above results of the examples confirmed that the present invention makes it possible to minimize shrinkage of the polyolefin microporous film during the drying process, to enhance uniformity of quality, and to achieve high-speed continuous productivity.

As readily understood by a person of ordinary skill, the term “strip-like and film-like microporous film precursor,” as used in the specification, means that such microporous film precursor is formed in the shape of a strip having a thickness being that of a film.

### DESCRIPTION OF THE NUMERICAL SYMBOLS

The following is a list of reference numerals and associated parts as used in this specification and drawings:

| Reference Numeral | Part |
|---|---|
| 1 | Microporous film manufacturing device (device |
| | for manufacturing polyolefin microporous film) |
| 2 | Resin kneading device |
| 3 | Die |
| 4 | Metallic roll |
| 5 | Stretching machine |
| 6 | Extraction solvent tank |
| 7 | Preliminary drying chamber |
| 8 | Main drying chamber (drying chamber) |
| 11 | Air blow nozzle |
| T1 | Liquid seal tank |
| T2 | Liquid seal tank |
| T3 | Liquid seal tank |
| 15 | Air blow nozzle (drying means) |
| 18 | Tenter (movement means) |
| 41 | Tenter clip (constraining means) |
| F | Microporous film, film-like microporous film |
| | precursor |
| R1 | Roll (conveying means) |
| R2 | Roll (conveying means) |
| R3 | Roll (conveying means) |
| R4 | Roll (conveying means) |
| R5 | Roll (conveying means) |
| DR | Drying roll |

The scope of the claims should not be limited by the preferred embodiments and examples, but should be given the broadest interpretation consistent with the written description as a whole.

1. A device for manufacturing a polyolefin microporous film, wherein a microporous film precursor obtained by mixing a polyolefin resin material and a plasticizer is stretched into a form of film and made into a strip-like and film-like microporous film precursor and a process for replacing the plasticizer with a solvent, followed by evaporating and drying the solvent in a drying chamber or a process for evaporating and drying the plasticizer in a drying chamber is performed; the device comprising:
a) a movement mechanism having a constraining means capable of mechanically constraining both widthwise edge parts of the strip-like and film-like microporous film precursor in the drying chamber, the movement mechanism conveying the strip-like and film-like microporous film precursor in a state in which both widthwise edge parts of the strip-like and film-like microporous film precursor are constrained by the constraining means;
b) a drying means for heating, in air, the strip-like and film-like microporous film precursor conveyed by the movement mechanism and for causing the solvent or the plasticizer to evaporate from the strip-like and film-like microporous film precursor, and
c) a liquid seal tank for storing a predetermined sealing liquid, the sealing liquid segregating the atmosphere in the drying chamber from the external atmosphere,
wherein both widthwise edge parts of the strip-like and film-like microporous film precursor are constrained by the constraining means in the sealing liquid in the liquid seal tank.

2. The device for manufacturing a polyolefin microporous film according to claim 1, wherein the movement mechanism conveys the strip-like and film-like microporous film precursor upwards in a state in which both widthwise edge parts of the strip-like and film-like microporous film precursor are constrained by the constraining means.

3. The device for manufacturing a polyolefin microporous film according to claim 1, wherein the constraining means and the movement mechanism are a clip-type tenter.

4. The device for manufacturing a polyolefin microporous film according to claim 3, wherein the tenter is provided with a pair of rails provided on widthwise edges of the strip-like and film-like microporous film precursor and bearings that roll on the rails or a slide member that slides on the rails, and
wherein a composite material comprising a solid lubricant and a metal being used for the bearing or for at least one of the rail and the slide member.

5. The device for manufacturing a polyolefin microporous film according to claim 1, further comprising:
a) a preliminary drying chamber provided at a stage prior to the drying chamber, the preliminary drying chamber being separated from the drying chamber by the liquid seal tank;
b) conveying means for conveying the strip-like and film-like microporous film precursor in the preliminary drying chamber and for conveying the strip-like and film-like microporous film precursor from the preliminary drying chamber through the liquid seal tank into the drying chamber, and
c) means capable of drying the strip-like and film-like microporous film precursor conveyed by the conveying means in the preliminary drying chamber.

6. A method for manufacturing a polyolefin microporous film in which a microporous film precursor obtained by mixing a polyolefin resin material and a plasticizer is stretched into the form of a film and made into a strip-like and film-like microporous film precursor and a process for replacing the plasticizer with a solvent, followed by evaporating and drying the solvent in a drying chamber or a process for evaporating and drying the plasticizer in a drying chamber is performed; the method comprising:
a) a step for mechanically constraining both widthwise edge parts of the strip-like and film-like microporous film precursor before the drying process; and
b) a step for conveying the strip-like and film-like microporous film precursor into the drying chamber in a state in which both widthwise edge parts of the strip-like and film-like microporous film precursor are mechanically constrained and for heating the strip-like and film-like microporous film precursor being conveyed, thereby causing the solvent or the plasticizer to evaporate from the strip-like and film-like microporous film precursor.

7. The method for manufacturing a polyolefin microporous film according to claim 6, wherein in the step for mechanically constraining both widthwise edge parts of the strip-like and film-like microporous film precursor before the drying process, both widthwise edge parts of the strip-like and film-like microporous film precursor are mechanically constrained in a sealing liquid stored in a liquid sealing tank provided in order to separate the atmosphere in the drying chamber and the exterior atmosphere from each other.

8. The method for manufacturing a polyolefin microporous film according to claim 6, wherein before the drying process and before the step for mechanically constraining both widthwise edge parts of the strip-like and film-like microporous film precursor, a step for causing the solvent or the plasticizer to evaporate from the strip-like and film-like microporous film precursor in a preliminary drying chamber provided at a stage prior to the drying chamber and a step for conveying the strip-like and film-like microporous film precursor from the preliminary drying chamber to the drying chamber are performed, and after the step for mechanically constraining both widthwise edge parts of the strip-like and film-like microporous film precursor, the drying process in the preliminary drying chamber is discontinued and the conveying speed of the drying device as a whole is increased.

9. The method for manufacturing a polyolefin microporous film according to claim 6, wherein in the drying chamber, the strip-like and film-like microporous film precursor is conveyed upwards in a state in which both widthwise edge parts of the strip-like and film-like microporous film precursor are mechanically constrained.

10. A method for manufacturing a polyolefin microporous film in which a microporous film precursor obtained by mixing a polyolefin resin material and a plasticizer is stretched into the form of a film and made into a strip-like and film-like microporous film precursor, and the continuously conveyed film-like microporous film precursor is subjected to a process of replacing the plasticizer with a solvent, followed by evaporating and drying the solvent in the drying chamber; the method comprising:
a) a step for mechanically constraining both widthwise edge parts of the strip-like and film-like microporous film precursor at an entrance side of the drying chamber;
b) a step for commencing extraction of the plasticizer from the film-like microporous film precursor using a solvent in an extraction solvent tank disposed upstream of the drying chamber; and
c) a step for conveying the strip-like and film-like microporous film precursor into the drying chamber and for heating the strip-like and film-like microporous film precursor being conveyed, thereby causing the solvent to evaporate from the strip-like and film-like microporous film precursor,
wherein the extraction of the plasticizer is commenced in the extraction solvent tank after both widthwise edge parts of the strip-like and film-like microporous film precursor are mechanically constrained at the entrance side of the drying chamber.
